(19) United States
(12) Patent Application Publication
(10) Pub. No.: US 2005/0253859 A1
(43) Pub. Date: Nov. 17, 2005

(54) System LSI and data processing system

(75) Inventors: Yoshitaka Takahashi, Chiyoda-ku (JP); Yoshiyuki Matsumoto, Chiyoda-ku (JP); Takanobu Naruse, Chiyoda-ku (JP); Seiichi Saito, Chiyoda-ku (JP); Yoshitaka Takahashi, Chiyoda-ku (JP)

Correspondence Address: CROWELL & MORING LLP;INTELLECTUAL PROPERTY GROUP, P.O. BOX 14300, WASHINGTON, DC, 20044-4300, US

(73) Assignee: Renesas Technology Corporation, Chiyoda-ku (JP)

(21) Appl. No.: 11/127,133

(22) Filed: May 12, 2005

(30) Foreign Application Priority Data
May 13, 2004 (JP) 2004-143629

(51) Int. Cl. G09G 5/39; G06F 13/28

(52) U.S. Cl. 345/531

(57) ABSTRACT

The system LSI has a MCU, a memory access control means equipped with unified memory interfaces with which at least two lines of unified memories A and B can be connected. In the main unit of the data processing system, the purpose of each unified memory is set like “mainly for main storage” or “mainly for display” by software in accordance with the operating status of the data processing system so as to adjust the memory access performance. In addition, the system has a means for specifying the unified memory to access and area therein for every display plane to be controlled by the display control circuit.

This application calims the benefit of priority under 35 U.S.C. § 119 to Japanese Patent Application No. 2004-143629, filed on May 13, 2004, the entire disclosure of which is herein expressly incorporated by reference.

### FIELD OF THE INVENTION

The present invention relates to a system LSI and a data processing system constructed using the LSI, particularly to a system LSI and a data processing system based on a memory access method with which both CPU processing and data processing such as image processing are operated.

### BACKGROUND OF THE INVENTION

One of the prior arts concerning the memory access method is a technique for putting the main storage and image memory into one integrated memory as disclosed in Japanese Patent Laid-Open Announcement No. Hei 11-510620 (1999). This is called as unified memory. A similar construction is disclosed also in U.S. Pat. No. 5,790,138.

In the description hereunder, the unified memory refers to a physically single storage device that can possess inside both an area CPU (command processing section) accesses and an area other units (including display control section) for data processing purpose such as image processing.

Since the main storage and image memory need not be distinguished in case of a unified memory constructed as above, it produces merits that the size of external memory connected to the LSI can be decreased and that the number of signal pins of the LSI for connecting the main storage and image memory can be deducted. While the unified memory construction produces merits as above, it also leads to a demerit that the performance of the main storage access and image memory access may possibly deteriorate, that is, the system performance may possibly drop because the main storage access and image memory access get to compete with each other.

Japanese Patent Laid-Open No. 2002-73526 discloses a memory access method for the unified memory construction aiming to control the system performance drop. In this memory access method, the interface between LSI and integrated memory is provided separately from the interface between the LSI and input/output devices so as to control the system performance drop.

A data processing system that is constructed using a system LSI and required to perform both CPU processing and data processing such as image processing includes, for example, a car navigation system. In a car navigation system, there arises two cases depending upon the operating status of the system: one where particularly the main storage performance needs to improve and the other where particularly the access performance of image memory needs to improve. For example, the case where the main storage access performance needs to improve is a case where voice recognition is processed by the CPU and where the map data stored in a storage device such as hard disk drive is developed on the main memory and route searching is performed by the CPU. The case where the image memory access performance needs to improve is a case where the number of display planes to be superposed by a display function is large or where multiple displays are controlled by one car navigation system.

### SUMMARY OF THE INVENTION

In case of a conventional system LSI and a data processing system using the LSI, wherein the unified memory construction as above is employed, there arises a problem that the main storage access by the CPU gets to compete with the image memory access by other units and consequently the performance may possibly deteriorate. In addition, it is difficult to adjust the CPU performance, i.e. main storage access performance and data processing performance, i.e. image memory access performance.

The present invention has been made in view of the above problems and an object of the invention is to offer a system LSI employing the unified memory construction that can eliminate the performance drop due to the competition between the main storage access and image memory access and adjust the memory access performance including the main storage access performance and image memory access performance and a data processing unit constructed using the system LSI that can perform data processing efficiently.

Of the inventions disclosed in this application, representative ones are briefly summarized as follows:

In order to achieve the above object, the system LSI of the invention is equipped with a memory access control means having a unified memory interface with which at least two lines of unified memories can be connected so as to adjust the memory access performance including the main storage access performance and image memory access performance. This memory access control means is a means for controlling the access by a command processing (CPU) and other units such as display control section to the at-least two lines of unified memories.

The system LSI of the invention comprises a command processing section, display control section (display control circuit), and memory access control means (MCU) which at least two physically different storage devices (unified memories) can be connected with and controls the access to the storage devices; employing a so-called unified memory construction wherein the storage area of the storage devices can have an area to be accessed by the command processing section and an area to be accessed by the display control section. In addition, in this system LSI, the area to be accessed by the command processing section for main storage purpose and the area to be accessed by the display control section for display purpose (for image memory purpose) are utilized separately based on the purpose of the access to the at-least two storage devices via the memory access control means.

Memories are utilized separately as follows, for example. In case the CPU performance needs to be given the priority, the area to be accessed for main storage is secured in one unified memory, and in case the display performance needs to be given the priority, area to be accessed for main storage is not secured but instead the area to be accessed for display is secured in each unified memory.

In the above system LSI of the invention, the display control section has a function of controlling multiple image planes and has a means for specifying which of the storage device to access for each of the image planes. That is, disposition of data of the multiple image planes into the storage device and area therein is specified independently.

In the above system LSI of the invention, the function of the display control section for controlling multiple image planes is a function of superposing the multiple image planes as a display plane,, and which area of the storage device to access is specified for each of the image planes.

In the above system LSI of the invention, the display control section has a register for specifying where to access for each of the image planes, and makes an access for each of the image planes in accordance with the setting in the register.

In addition, the system LSI of the invention comprises a command processing section, image input section (video input circuit), and memory access control means which at least two physically different storage devices (unified memories) can be connected with and controls the access to the storage devices; the storage area of the storage devices can have an area to be accessed by the command processing section and an area to be accessed by the image input section; and the area to be accessed by the command processing section for main storage purpose and the area to be accessed by the image input section for image input purpose are utilized separately based on the purpose of the access to the at-least two storage devices via the memory access control means.

In addition, the system LSI of the invention comprises a command processing section, voice processing section, and memory access control means which at least two physically different storage devices (unified memories) can be connected with and controls the access to the storage devices; the storage area of the storage devices can have an area to be accessed by the command processing section and an area to be accessed by the voice processing section; and the area to be accessed by the command processing section for main storage purpose and the area to be accessed by the voice processing section for voice processing purpose are utilized separately based on the purpose of the access to the at-least two storage devices via the memory access control means.

In the above system LSI of the invention, the method of memory access employed is such that the access to the at-least two storage devices can be specified using address. For example, it the specific bit of the address is “1”, the first unified memory is to be accessed, and if it is “0”, the second unified memory is to be accessed.

In the above system LSI of the invention, the method of memory access employed is such that the access to the at-least two storage devices can be specified using register.

In addition, a data processing system of the invention comprises the above system LSI, at least two physically different storage devices (unified memories) connected with the system LSI, and external devices; and the system LSI utilizes separately the area to be accessed by the command processing section and the area to be accessed by the display control section based on the purpose of the access to the at-least two storage devices, including the access by the external devices, and in accordance with the operating status of the system.

The purpose of the multiple unified memories is set, for example, as “mainly for display purpose”, “mainly for main storage purpose” or “all for display purpose” depending upon the performance that needs to be given the priority. Then, the purposes of the unified memories are utilized properly using software in accordance with the operations status of the data processing system.

Similarly, the data processing system of the invention is equipped with an image input section (video input circuit) and voice processing section and it is possible to specify which one of the at-least two storage devices (unified memories) shall be accessed for data processing by the image input section and voice processing section.

The effects that can be produced by representative ones of the inventions disclosed in this application are explained briefly hereunder.

With the system LSI and data processing system of the present invention, the memory access performance can be adjusted so as to give the priority on the CPU performance to lower the latency of the main storage access or give the priority on the data processing performance (display performance) for lowering the latency of the access for data processing purpose in accordance with the operating status of the system, and accordingly there is produced an advantage that the system performance can improve.

In addition, when the system LSI of the present invention is applied to a data processing system such as car navigation system, if the car navigation system is constructed by employing only one of the multiple unified memory interfaces and connecting with a single unified memory, a low-cost car navigation system can be constructed. Furthermore, when a car navigation system having higher performance is needed, such system can be constructed by employing two or more unified memory interfaces and connecting with two or more lines of the unified memories.

By providing the system LSI with at-least two unified memory interfaces as described above, multiple data processing systems of different performance can easily be constructed using only one system LSI. Since the same system LSI is applicable to multiple data processing systems of different performance, it becomes no longer necessary to develop a suitable system LSI individually, which is an effect of the invention.

Other objects, advantages and novel features of the present invention will become apparent from the following detailed description of the invention when considered in conjunction with the accompanying drawings.

### BRIEF DESCRIPTION OF DRAWINGS

FIG. 1 shows a whole construction of a car navigation system as an embodiment of the data processing system of the present invention.

FIG. 2 shows a construction of the car navigation system unit including the system LSI according to an embodiment of the invention.

FIG. 3 is an explanatory figure showing the superposition of multiple display for a display unit in the system LSI and data processing system according to an embodiment of the invention.

FIG. 4 shows two memory maps from the view point of the CPU 201 contained in the system LSI of the embodiment.

FIG. 5 shows two memory maps from the view point of the CPU located outside the system LSI of the embodiment.

FIG. 6 shows a construction example of the memory controller 205 in the system LSI of the embodiment.

FIG. 7 shows the unified memory access of the embodiment with the priority on the CPU performance.

FIG. 8 shows the unified memory access of the embodiment with the priority on the display performance.

FIG. 9 shows an example of setting the priority of access to two lines of the unified memories, particularly a case where each line is set equal.

FIG. 10 shows an example of setting the priority of access to two lines of the unified memories, particularly a case where each line is set different.

FIG. 11 is an explanatory figure of the sub-round robin for setting the priority of access shown in FIG. 9 and FIG. 10.

FIG. 12 shows the worst latency of the unified memory from the view point of each device in a case where, under the access priority setting as shown in FIG. 9, only three accesses, CPU, data transmission from the SRAM by the DMAC, and graphic device compete with each other.

FIG. 13 shows the worst latency of the unified memory access from the view point of the graphic device in a case where, under the access priority setting as shown in FIG. 10, only three accesses, CPU, data transmission from the SRAM by the DMAC, and graphic device compete with each other.

FIG. 14 shows the worst latency of the unified memory access from the view point of the CPU in a case where, under the access priority setting as shown in FIG. 10, only three accesses, CPU, data transmission from the SRAM by the DMAC, and graphic device compete with each other.

FIG. 15 shows a construction of the arbitration circuit in the system LSI of the embodiment.

FIG. 16 shows another construction example of the memory controller in the system LSI of the embodiment.

### DESCRIPTION OF THE PREFERRED EMBODIMENTS

Preferred embodiments of the present invention are described hereunder in detail, using figures. In all figures used for describing the preferred embodiments, same symbol is given to the same part/component as a principle and no repeated description is made.

A system LSI according to a preferred embodiment of the present invention and a data processing system employing the system LSI are described hereunder. This embodiment, employing a unified memory connected to the system LSI, achieves an object that the accesses to the unified memory can be arbitrated, that is, the main storage access performance of the CPU and data processing access performance of other unit, such as for image processing, can be adjusted in accordance with the operating status of the data processing system.

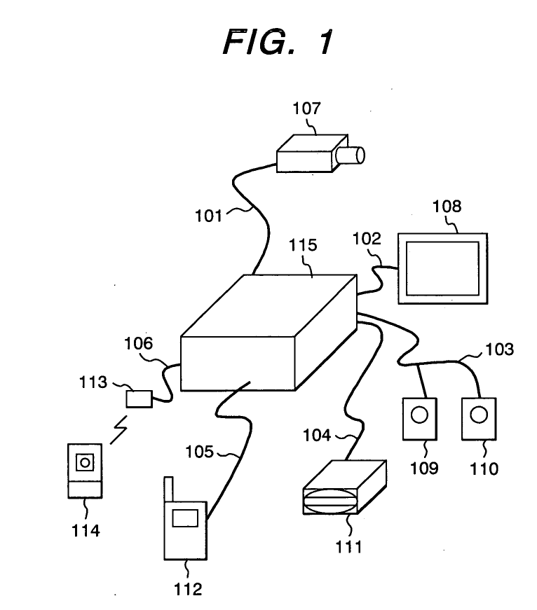

FIG. 1 shows a construction example of the data processing system according to an embodiment of the present invention. Particularly in this embodiment, a car navigation system is described as the data processing system. In FIG. 1, the car navigation system comprises the main body 115, camera (video input device) 107, liquid crystal display (display unit) 108, storage device 111, speakers (voice output devices) 109, 110, mobile phone 112, remote controller receiver 113, remote controller 114, and signal lines 101 to 106.

The main body 115 is a car navigation system unit including the system LSI according to the embodiment of the invention, two lines of unified memories connected thereto, and external devices. Each of the camera 107, liquid crystal display 108, speakers 109, 110, storage device 111, mobile phone 112, and remote controller receiver 113 is connected to the main body 115 by each signal line 101 to 106.

The camera 107 sends video picture taken by the camera to the main unit 115. The liquid crystal display 108 displays image based on the image signal outputted from the main unit 115. The speakers 109, 110 output voice based on the voice signal outputted from the main unit 115. The main unit 115 reads map data and voice guidance data from the storage device 111. The main unit 115 communicates with the outside by the mobile phone 112. User gives an instruction to the car navigation system unit 115 via the remote controller 114 and the instruction is received by the remote controller receiver 113 and transmitted to the main unit 115.

FIG. 2 shows a construction of the car navigation system unit 115 including the system LSI 211 according to an embodiment of the invention. The main unit 115 comprises the system LSI 211, unified memory connected thereto, and external devices. The system LSI 211 is a semiconductor integrated circuit formed on a silicon substrate, including modules such as CPU (command processor) 201 and display control circuit 203. The system LSI 211 comprises the CPU 201, VIN (video input circuit) 202, display control circuit 203, voice processing circuit 204, MCU (memory controller) 205, graphic processor (graphic device) 223, first bus 213-1 (address), 213-2 (data), second bus 222-1 (address), 222-2 (data), ARB (arbitration circuit) 220, and bus bridge 226. The system LSI 211 also includes the unified memory A210, unified memory B212, third bus 214-1 (address), 214-2 (data), CPU (external CPU) 206, SRAM 207, FLASH (flash memory) 208, peripheral I/F (peripheral interface) 209, DMAC (direct memory access controller) 225, ARB (arbitration circuit) 221, and power monitor circuit 224, all of which are connected with the system LSI 211.

The system LSI 211 according to this embodiment is constructed as a system LSI comprising two unified memory interfaces through which two lines of unified memories can be connected. The data processing system according to this embodiment is constructed as a system where two unified memory A210 and unified memory B212 are connected with the two unified memory interfaces. In the description hereunder where the two unified memories A and B need not be particularly distinguished from each other, they are called as “unified memories A and B”.

In FIG. 2, the CPU 201 is connected with the first bus 213-1, 213-2, and accesses each module via the first bus 213-1, 213-2. The video input circuit 202, display control circuit 203, voice processing circuit 204, memory controller 205, arbitration circuit 220, and third bus 214-1, 214-2 are also connected with the first bus 213-1, 213-2.

The video input circuit 202 receives a video input signal from the camera 107 via the signal line 101, captures the outside image in a buffer contained in the video input circuit 202, and then writes it periodically into the image memory area in the unified memories A and B via the first bus 213-1, 213-2 and MCU 205.

The display control circuit 203 outputs a signal for display to the external liquid crystal display 108 via the signal line 102 and reads data necessary for display from the image area of the unified memories A and B via the first bus 213-1, 213-2 and MCU 205.

The voice processing circuit 204 outputs a voice signal necessary for driving the speakers 109, 110 via the signal line 103 and reads data necessary for voice output from the area of the unified memories A and B via the first bus 213-1, 213-2 and MCU 205.

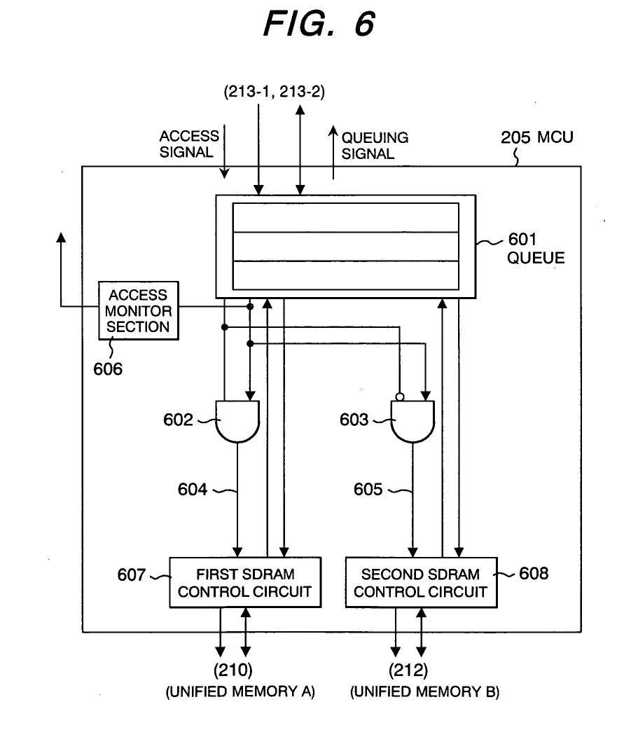

The memory controller 205 is a memory access control means equipped with interfaces for the two lines of the unified memories A/B. It receives a READ or WRITE access signal from the CPU 201, display control circuit 203 and other unit via the first bus 213-1, 213-2 and controls the unified memories A and B. Detailed construction of the memory controller 205 will be shown later, using FIG. 6.

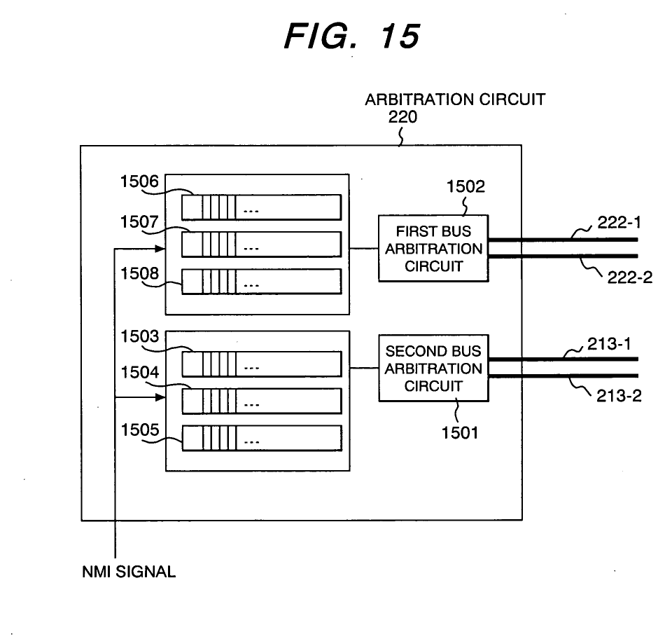

The arbitration circuit 220 arbitrates the accesses that compete with each other on the first bus 213-1, 213-2 and second bus 222-1, 222-2 in accordance with the preset priority. Detailed construction of the arbitration circuit 220 will be shown later, using FIG. 15.

The external CPU 206, SRAM 207, peripheral interface 209, flash memory 208 and arbitration circuit 221 are connected with the third bus 214-1, 214-2 outside the system LSI 211.

The external CPU 206, which is a CPU located outside the system LSI 211, can access the unified memories A and B via the third bus 214-1, 214-2 and first bus 213-1, 213-2. The SRAM 207, which is accessed by the external CPU 206, is a memory for storing the data from the system LSI 211 temporarily. Since the SRAM 207 is backed up by a battery, not shown, data in the SRAM 207 can be retained by the battery even when the main power supply to the car navigation system fails.

The peripheral interface 209 is connected with the storage device 111, mobile phone 112 and remote controller receiver 113 via the signal lines 104, 105, 106. The flash memory 208 is a memory for storing information such as a searched route data on a map that needs to be stored even after the power is turned off.

The arbitration circuit 221 arbitrates the accesses that compete with each other on the third bus 214-1, 214-2 in accordance with the preset priority. The DMAC 225 enables the SRAM 207, peripheral I/F 209 and flash memory 208 connected with the third bus 214-1, 214-2 to access the first bus 213-1, 213-2 or second bus 222-1, 222-1. The DMAC 225 is connected with the third bus 214-1, 214-2.

In the system LSI 211, the arbitration circuit 220 receives a NMI signal (non-maskable interrupt signal) from the power monitor circuit 224. The graphic device 223 reads a command string called a display list, stored in the unified memories A and B, executes a graphic operation while outputting an interim result to the unified memories A/B, and outputs the final graphic data to the unified memories A and B.

Each of the CPU 201, video input circuit 202, display control circuit 203, arbitration circuit 220, graphic device 223, memory controller 205, voice processing circuit 204, all connected with the first bus 213-2, 213-2, and third bus 214-1, 214-2 is connected with the second bus 222-1, 222-2. The third bus 214-1, 214-2 and second bus 222-1, 222-2 are connected with each other via the bus bridge 226, and so are the third bus 214-1, 214-2 and first bus 213-1, 213-2.

In this embodiment, each unified memory A and unified memory B is constructed as a SDRAM (synchronous DRAM). The memory bus of the SDRAM operates in synchronism with a clock frequency of a specified cycle.

Since the memory access by the video input circuit 202 and display control circuit 203 to the unified memories A and B needs to be real-time, the access is so operated that no page error is caused in the unified memory SDRAM, during a single transaction. Single transaction means an access for filling a buffer in the video input circuit 202 or display control circuit 203.

Although the memory access by the voice processing circuit 204 also needs to be real-time, page error caused in the SDRAM is allowable because the required real time is not so strict as for the video input circuit 202 and display control circuit 203. Accordingly, this system LSI and data processing system of this embodiment allow page error.

The system LSI 211 has the MCU 205 that is a memory access control means equipped with the unified memory interfaces with which at least two lines of unified memories A210, B212. The storage area in the unified memories A and B can have both the area to be accessed by the CPU 201 and the area to be accessed by the display control circuit 203. In the main unit 115 of the data processing system, based on the purpose of an access to the at-least two unified memories A and B via the MCU 205, an area to be accessed mainly by the CPU 201 for main storage purpose and an area to be accessed mainly by the display control circuit 203 for display purpose are utilized separately. In accordance with the operating status of the data processing unit, the utilization of each unified memory is set, for example, as “mainly for main storage access” and “mainly for display access” by software so as to adjust the memory access performance. In addition, the system is equipped with a means for independently specifying the unified memory and area to be accessed for every display plane controlled by the display control circuit 203.

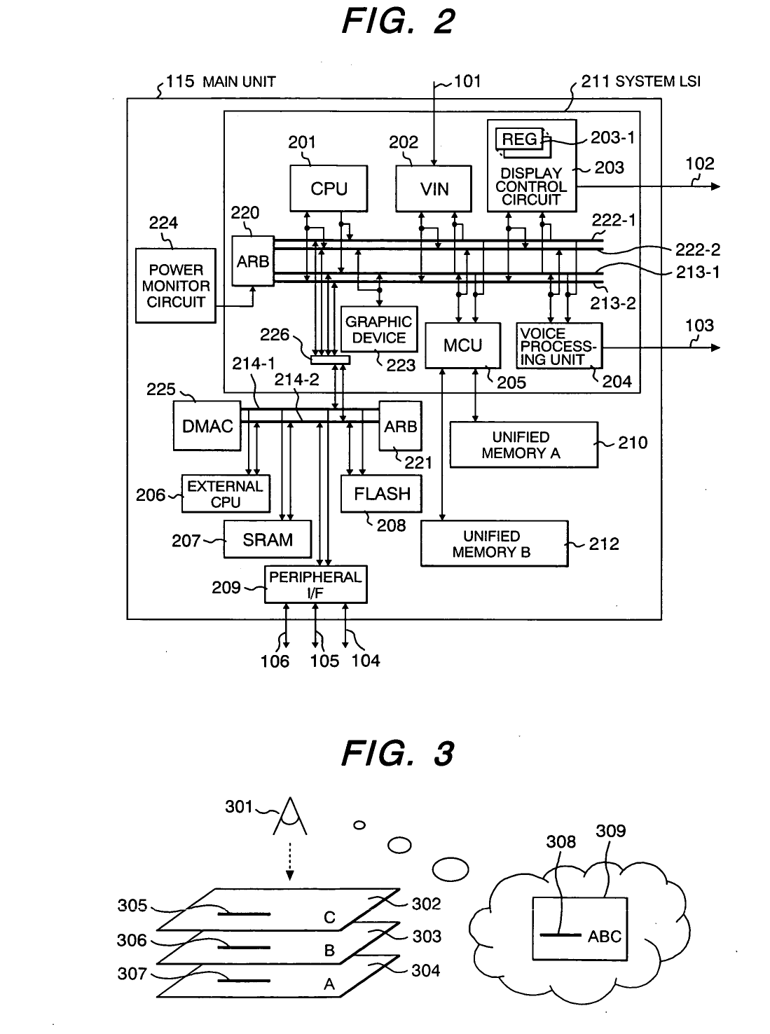

FIG. 3 is an explanatory figure showing the superposition of multiple display planes by the display control circuit 203 of the system LSI 211. The display control circuit 203 has a function of controlling multiple image planes, and particularly a function of superposing multiple display planes for the display unit, liquid crystal display 108. This function enables the car navigation system to provide information display made of superposed multiple images.

Each 302, 303 and 304 in the left of FIG. 3 is an independent display plane and these three screens are superposed in this example. Each 305, 306 and 307 is an image, showing a line and an alphabet, drawn on each display plane. 301 is a view point of a human, who sees the screen of the display unit 108 from the view point 301.

When a human sees the display screen comprising superposed multiple display planes 302 to 304 from the view point 301, he sees a screen like 309 in the right of FIG. 3, where the image 308 containing a line and alphabets is the superposition of the images 305, 306 and 307. During the superposition by the display control circuit 203, transmission of color and other processing are also operated.

The present invention has a means for specifying the access to the unified memories A and B for every one of the multiple image planes. That is to say, it is possible to specify to which one of the multiple unified memories and in which area in the memory each of multiple image planes should be disposed. An example will be described later.

Although multiple image planes are superposed by the display control circuit 203 in this embodiment, the present invention is applicable to a case where a screen if an excessive display size is divided into multiple images for the ease of processing or where multiple displays are controlled by a single car navigation system.

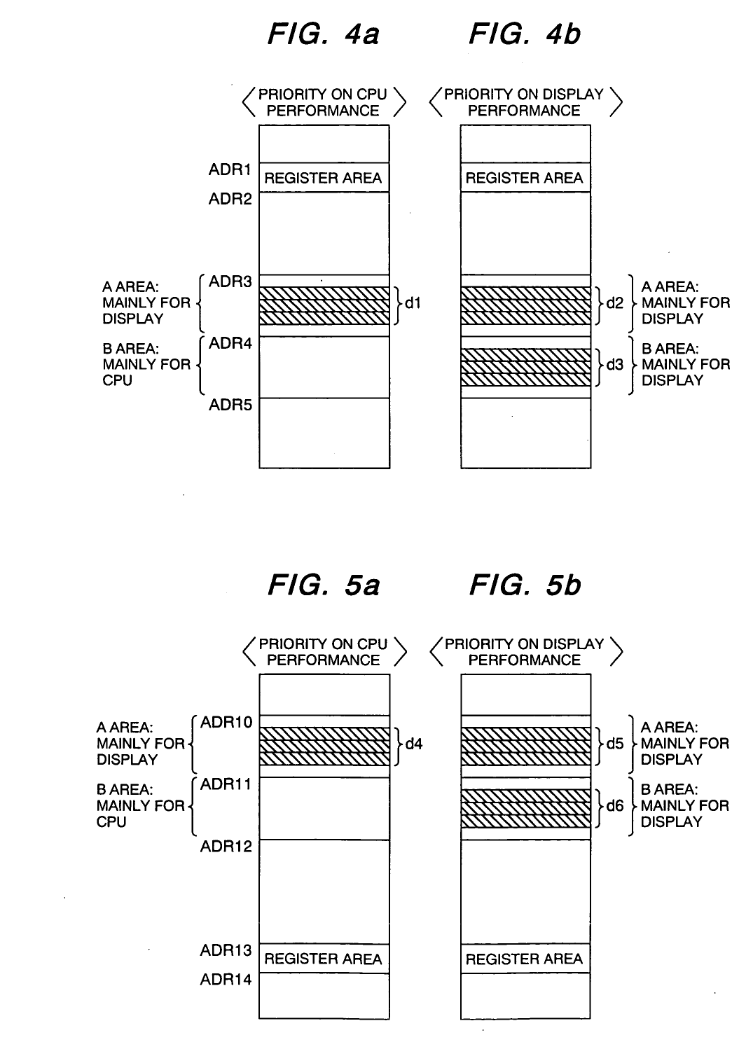

FIG. 4 shows a memory map from the view point of the CPU 201 contained in the system LSI 211. FIG. 4(a) is a memory map with the priority on the CPU performance. FIG. 4(b) is a memory map with the priority on the display performance. It is assumed that (b) corresponds to the same address as in (a).

A case with the priority on the CPU performance means that the priority is required to be put on the CPU 201 performance, that is, the reduction of latency of the main storage access for the CPU 201 rather than on the display performance such as greater number of display planes and wider display area for the display unit 108 connected with the display control circuit 203. On the other hand, a case with the priority on the display performance means that the priority is required to be put on the display performance such as greater number of display planes and wider display area for the display unit 108 rather than on the CPU 201 performance.

In this embodiment, the method of specifying the address for an access to the unified memories A/B is such that the disposition of the superposed display planes on the display unit 108 is determined by specifying the display start address in a register (203-1 in FIG. 2) contained in the display control circuit 203. In short, the register storing the display start address is specified as the operand of a command. Similarly, the disposition of a captured image in the unified memories A and B is determined by specifying the address in a register (not shown) contained in the video input circuit 202.

In this embodiment, which memory area to access, unified memory A or unified memory B, shall be judged by whether the specific bit of the address is “1” or not. In other embodiment, it is also possible to specify which to access, unified memory A or unified memory B, by utilizing each register contained in the display control circuit 203 and video input circuit 202.

In FIG. 4(a), the area from ADR1 to ADR2 is the register area used for the method of specifying the address. The area from ADR3 to ADR4 is the area for the unified memory A. The area from ADR4 to ADR5 is the area for the unified memory B. An image memory area (shadowed area) d1 enough to superpose three screens is provided in the area for the unified memory A. No such image memory area as d1 is provided in the memory area for the unified memory B. The area for the unified memory A is used mainly for display processing. The memory for the unified memory B is used mainly for main memory access by the CPU 201.

In FIG. 4(b), the area from ADR1 to ADR2 is the register area used for the method of specifying the address. The area from ADR3 to ADR4 is the area for the unified memory A. The area from ADR4 to ADR5 is the area for the unified memory B. Each image memory area (shadowed area) d2, d3 enough to superpose three screens is provided in the area for the unified memory A and for the unified memory B. They are the image memory area enough for total six planes. Each area for the unified memory A and for the unified memory B is used mainly for display processing.

In this system LSI and data processing system, as shown in FIG. 4, the unified memories A and B are utilized separately for different purposes (a) and (b) in accordance with the operating status of the system. In this embodiment, the area for the unified memory A is used mainly as a CPU access area in case of (a) and, on the contrary, used mainly as an image memory area for three screens in case of (b). This difference results in the difference between the CPU performance and display performance.

Although every three image planes to be superposed and displayed are disposed in the unified memories A and B in this embodiment, but other various embodiments are also available. For example, where more unified memories are connected, it is possible to dispose each image plane to be displayed in individual unified memory.

FIG. 5 shows a memory map from the view point of the CPU 206 located outside the system LSI 211. FIG. 5(a) is a memory map with the priority on the CPU performance. FIG. 5(b) is a memory map with the priority on the display performance. Similarly as in FIG. 4, the area for the unified memory A (area from ADR10 to ADR11), area for the unified memory B (area from ADR11 to ADR12) and register area (area from ADR13 to ADR14) are secured. The areas d4, d5 and d6 are each image memory area for three planes. The role of each area is the same as in FIG. 4.

FIG. 6 shows a construction example of the memory controller 205 that is the memory access means in the system LSI 211. The memory controller 205 comprises a queue 601, logic circuits 602, 603, SDRAM control circuits 607, 608, and access monitor circuit 606. The queue 601 queues an access signal received from the first bus 213-1, 213-2 and outputs the access signal to the signal line 604 or signal line 605 via the logic circuit 602 or logic circuit 603. At the same time of the queuing operation, the queue 601 returns a queuing completion signal to the first bus 213-1, 213-2. Since no passing of the access data is caused inside the queue 601, the access received by the queue 601 is executed sequentially. The queuing completion signal returned to the first bus 213-1, 213-2 is utilized when “next command shall be executed only after the access result is surely reflected on the memory” is needed in the CPU 201.

The signal line 604 is connected with the first SDRAM control circuit 607, and the signal line 605 is connected with the second SDRAM control circuit 608.

When the specific bit of the access signal from the first bus 213-1, 123-2 is “1”, the logic circuit 602 outputs the access signal from the first bus 213-1, 123-2 to the signal line 604. When the specific bit of the access signal from the first bus 213-1, 213-2 is “0”, the logic circuit 603 outputs the access signal from the first bus 213-1, 213-2 to the signal line 605.

The access monitor circuit 606 monitors accesses to the unified memory A and unified memory B, monitoring the accesses between the unified memories A and B where an access to the unified memory A is begun first in a single transaction and then access to the unified memory B follows or an access to the unified memory B is begun first and then access to the unified memory A follows.

In this invention, it is important to determine for what main purpose the unified memory A and unified memory B shall be utilized, that is, whether the priority is put on the CPU performance or on the display performance based on the condition of the system. Because of the above, if an access in a single transaction is to access both the unified memory A and unified memory B, this condition is recorded as an error. A register is contained in the access monitor circuit 606 and the above error is recorded there. An interruption signal, although not shown, is connected from the access monitor circuit 606 to the CPU 201, and an error is reported to the CPU 201 in case of interruption.

The first SDRAM control circuit 607 and second SDRAM control circuit 608 are connected with the unified memory A 210 and unified memory B 212, respectively. Each SDRAM control circuits 607 and 608 are a control circuit that issues a command to its corresponding unified memory SDRAM. In addition, each SDRAM control circuits 607 and 608 have a setting register (not shown) for setting the bit width (bus width) of the unified memories A and B, respectively, and so the system can be constructed using different width between the unified memories A and B or the same width. In addition, since each SDRAM control circuits 607 and 608 are independent, it is possible to construct a system using either one of the unified memories A and B.

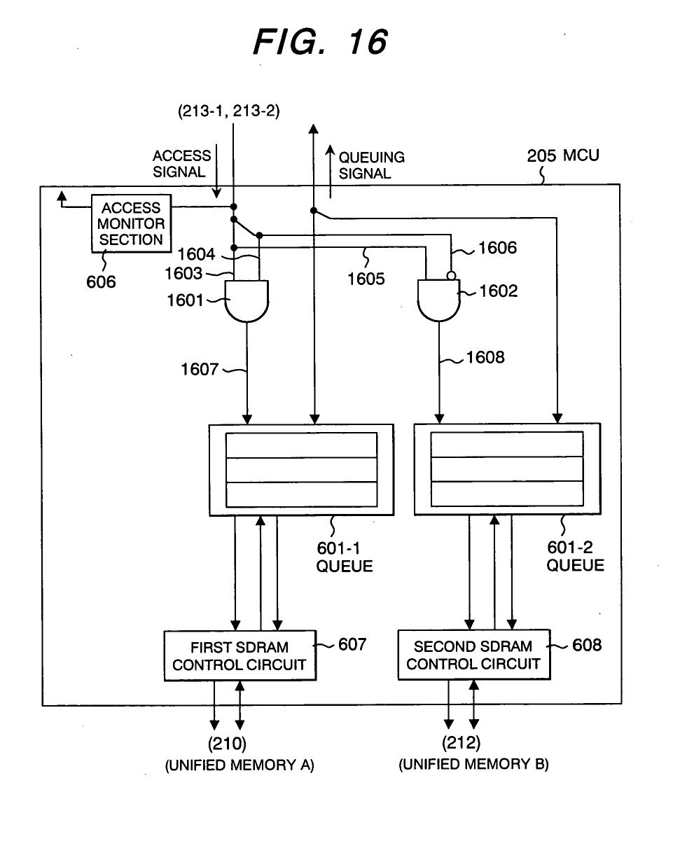

FIG. 16 shows another construction example of the memory controller 205, which is different from the one in FIG. 6. FIG. 16 shows the second construction example of the memory controller 205 that is the memory access control means in the system LSI 211. The memory controller 205 comprises queues 601-1, 601-2, logic circuits 1601, 1602, SDRAM control circuits 607, 608, and access monitor circuit 606. The queue 601-1 queues an access signal received from the first bus 213-1, 213-2 and outputs the access signal to the first SDRAM control circuit 607 via the logic circuit 1601. At the same time of the queuing operation, the queue 601-1 returns a queuing completion signal to the first bus 213-1, 213-2. Since no passing of the access data is caused inside the queue 601-1, the access received by the queue 601-1 is executed sequentially. The queuing completion signal returned to the first bus 213-1, 213-2 is utilized when “next command shall be executed only after the access result is surely reflected on the memory” is needed in the CPU 201. When the specific bit of the access signal from the first bus 213-1, 213-2 is “1”, the logic circuit 1601 outputs the access signal from the first bus 213-1, 213-2 to the signal line 1607. When the specific bit of the access signal from the first bus 213-1, 213-2 is “0”, the logic circuit 1602 outputs the access signal from the first bus 213-1, 213-2 to the signal line 1608. The queue 601-2 queues an access signal received from the first bus 213-1, 213-2 and outputs the access signal to the second SDRAM control circuit 608 via the logic circuit 1602. At the same time of the queuing operation, the queue 601-2 returns a queuing completion signal to the first bus 213-1, 213-2. Since no passing of the access data is caused inside the queue 601-2, the access received by the queue 601-2 is executed sequentially. The processes in the queue 601-1 and queue 601-2 are executed in parallel.

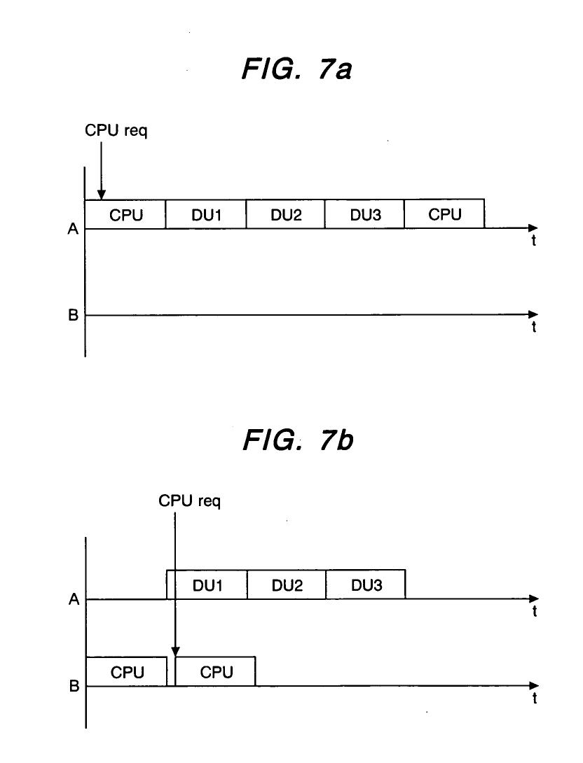

FIG. 7 is a chart for explaining the access with the priority on the CPU performance, showing the timing of access to the unified memories A and B. In FIG. 7(a), after the CPU 201 has first accessed to the unified memory A (shown as “CPU” in the figure), an access “DU1” for display processing is made by the display control circuit 203. No access has been made to the unified memory B. In the description hereunder, an access to the unified memories A and B by the CPU 201 is called the CPU access and an access to the unified memories A and B by the display control circuit is called the display access. In this embodiment, each display access “DU1 to DU3” particularly represents the access corresponding to each display plane of the three screens to be superposed by the display control circuit 203.

In FIG. 7(a), it is assumed that the display access is given the highest priority in the data processing system of this embodiment. Immediately after the beginning of the display access “DU1”, an access request is made from the CPU 201 (shown as “CPUreq” in the figure). Since this CPU request “CPUreq” competes with the display accesses “DU1 to DU3”, the CPU access is kept waiting until the access of the display access “DU3” has completed.

Generally speaking, display access is an access required of real time, and if real time is not available for the display access, there happens a problem that display goes out of order. Because the CPU request is kept waiting by the accesses “DU1 to DU3”, the CPU performance becomes worse than in a case where no waiting has been caused due to competition. In a system of a prior art that is equipped with only one unified memory, such condition as the accesses to the unified memory A as shown in FIG. 7(a) happens very frequently.

On the other hand, FIG. 7(b) shows a case where the unified memory A is used mainly for the display access and the unified memory B is used mainly for the main storage access (set as shown in FIG. 4(a)). The CPU access “CPU” is executed in the unified memory B to start with, and the display accessed “DU1 to DU3” are executed in the unified memory B immediately after it. Although the access request “CPUreq” by the CPU 201 is made in the unified memory B at the same timing as shown in FIG. 7(a), this CPU access can be executed immediately because the unified memory B is used mainly for main storage access and accordingly no display access “DU1 to DU3” has been made.

By comparing FIG. 7(a) with FIG. 7(b), it is understood that the timing of the second CUP access, that is, the latency improves in FIG. 7(b). Thus, the priority can be given on the CPU performance.

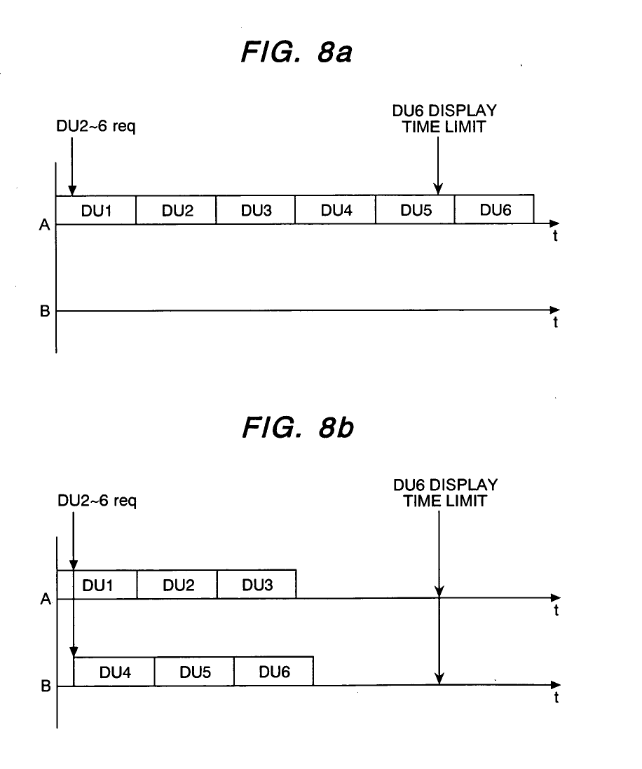

FIG. 8 is a chart for explaining the access with the priority on the display performance, showing the timing of accesses to the unified memories A and B. In FIG. 8(a), the unified memory A is used mainly for the display access and the unified memory B is used mainly for the main storage access. In this case, no CPU access is made to the unified memory B. In this embodiment, each display access “DU1 to DU6” represents the access corresponding to each display plane of the six screens to be superposed by the display control circuit 203.

Immediately after the display access “DU1” is made to the unified memory A, requests “DU2 to 6req” for the display accesses “DU2 to DU6” are made simultaneously. After the access of the display access “DU1” has completed, the display accesses “DU2” to “DU6” are executed one after another. Since display access is required of real time, display goes out of order if the access has not completed within a specified time limit. This embodiment is problematic because the display access “DU6” has not completed before the “DU6 display time limit” in FIG. 8(a) and accordingly disorder may possibly be caused in “DU6”, that is, on the sixth plane of the superposed display planes.

FIG. 8(b) shows a case where the unified memory A is used mainly for the display access and the unified memory B is not used mainly for the main storage access but used mainly for the display access as is the unified memory A (set as sown in FIG. 4(b)). In this embodiment, the unified memories A and B are supposed to dispose each three display planes. Supposing that the number of colors used and display size of each display plane are equal, the display access to the unified memory A and to the unified memory B generates a nearly equal amount of traffic.

In FIG. 8(b), immediately after the display access “DU1”, access requests “DU2 to 6req” for the display accesses “DU2 to DU6” are made similarly as in FIG. 8(a). In FIG. 8(b), the display area for “DU1 to DU3” is provided in the unified memory A and the display area for “DU4 to DU6” is provided in the unified memory B. When access requests for the display accesses “DU2 to DU6” are made, execution of the display access “DU4” begins in the unified memory B. The access of the display accesses “DU1 to DU3” is executed in the unified memory A, and the access of the display accesses “DU4 to DU6” is executed in the unified memory B. In FIG. 8(b), the access “DU6” has completed before the “DU6 display time limit”, and accordingly no disorder is caused on the display plane corresponding to “DU6”. Thus, the priority can be given on the display performance.

In the car navigation system that is a data processing system according to this embodiment, if main storage performance such as route search or voice recognition by the CPU operation is required, memories are arranged as shown in FIG. 4(a) so that the accesses shown in FIG. 7(b) can be executed. Thus, the CPU performance is fulfilled with high priority. Although the number of display planes to be superposed is limited to three, this limitation is inevitable as the route search and voice recognition are the processing that requires the CPU performance. If no limitation is made to the display performance even in case high CPU performance is required, it becomes necessary to provide dedicated display memories, resulting in higher cost of the car navigation system.

In the car navigation system that is a data processing system according to this embodiment, if the display performance (data processing performance) such as an increase of the number of superposed display planes, for example, up to six is required, memories are arranged as shown in FIG. 4(b) so that the accesses shown in FIG. 8(b) can be executed. Thus, the display performance is fulfilled with high priority. If it is attempted to make the main storage access to the unified memories A and B, because it compete with the display access and also because the display access is arbitrated with the top priority, the latency of the main storage access becomes worse than that of the display access. However, if no limitation to the CPU performance is made even in case high display performance is required, it becomes necessary to provide dedicated display memories, resulting in higher cost of the car navigation system.

Although the above description takes image memory access by the display control circuit 203 as an example to explain a case where the data processing performance is given the priority, the same applies to the unified memory access for data processing by other units like the video input circuit 202 and voice processing circuit 204. In this embodiment, similarly as in the case of the display control circuit 203, it is possible to specify to which one of the unified memories A/B and in which area in the memory should be accessed for data processing by the video input circuit 202 and voice processing circuit 204

In case of a construction where the unified memory access is made by the video input circuit 202, an image input section, the storage area in each unified memories A and B can have both the area to be accessed by the CPU 201 and the area to be accessed by the video input circuit 202, and based on the purpose of an access to the at-least two unified memories A and B via the MCU 205, a memory access control means, an area to be accessed mainly by the CPU 201 for main storage purpose and an area to be accessed mainly by the video input circuit 202 for image input purpose are utilized separately.

In case of a construction where the unified memory access is made by the voice processing circuit 204, the storage area in each unified memories A and B in the system LSI 211 can have both the area to be accessed by the CPU 201 and the area to be accessed by the voice processing circuit 204, and based on the purpose of an access to the at-least two unified memories A and B via the MCU 205, a memory access control means, an area to be accessed mainly by the CPU 201 for main storage purpose and an area to be accessed mainly by the voice processing circuit 204 for voice processing purpose are utilized separately.

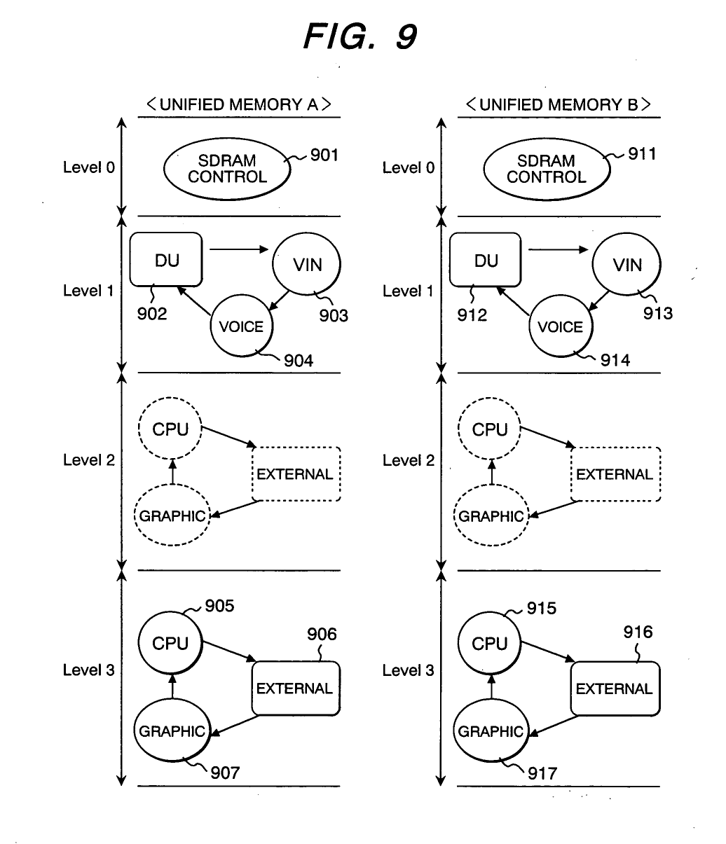

FIG. 9 shows an example of setting the priority of access to the unified memories A and B, particularly a case where both unified memories A and B are set equal. The access priority for each device (accessing body) in each line of the unified memories A and B is separated into Level 0 to Level 3. Each level is given the priority in order of Level 0>Level 1>Level 2>Level 3. Level 0 has the highest access priority and so, if it competes with an access request at a lower level, Level 0 is executed first.

Of these levels in the system LSI of this embodiment, the access priority setting can be altered only at Level 2 and Level 3. The access priority has been set in the priority setting registers 1503 and 1506 in the arbitration circuit 220.

The SDRAM control 901 is allocated to Level 0. It is the control such as refreshing the SDRAM to be executed by the memory controller 205.

Level 1 includes the display device access (DU) 902, video input access (VIN) 903, and voice access 904. The priority of the display device access 902, video input device 903 and voice access 904 in Level 1 is determined by round robin. The display device access 902 corresponds to the access by the display control circuit 203. The video input access 903 corresponds to the access by the video input circuit 202. The voice access 904 corresponds to the access by the voice processing circuit 204.

In this example, no device is set at Level 2. A device shown in dotted line means the device has not been set at the level in question. At Level 3, the CPU access 905, external device access 906, and graphic device access 907 are set. The priority of the CPU access 905, external device access 906, and graphic device access 907 in Level 3 is determined by round robin. The CPU access 905 corresponds to the access by the CPU 201. The external device access 906 corresponds to the access by each device connected with the third bus 214-1, 214-2. The graphic device access 907 corresponds to the access by the graphic device 223.

In FIG. 9, the same access priority is set for both unified memory A and unified memory B. Neither of them has a device given the access priority at Level 2. In addition, the display device access 902 and external device access 906 are further given the priority each by round robin. This will be described later.

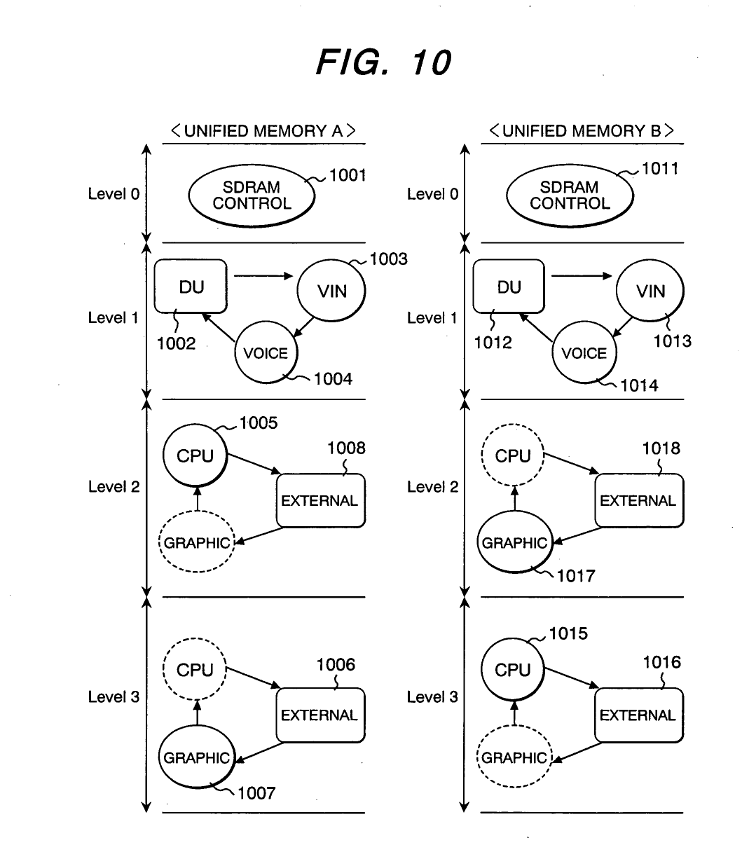

FIG. 10 shows an example of setting the priority of access to the unified memories A and B, particularly a case where the unified memories A and B are set different. The setting at Level 0 and Level 1 is the same as in FIG. 9. At Level 2, the CPU access 1005 and external device access 1008 are set for the unified memory A and the graphic device access 1017 and external device access 1018 are set for the unified memory B.

At Level 3, the graphic device access 1007 and external device access 1006 are set for the unified memory A and the CPU access 1015 and external device access 1016 are set for the unified memory B.

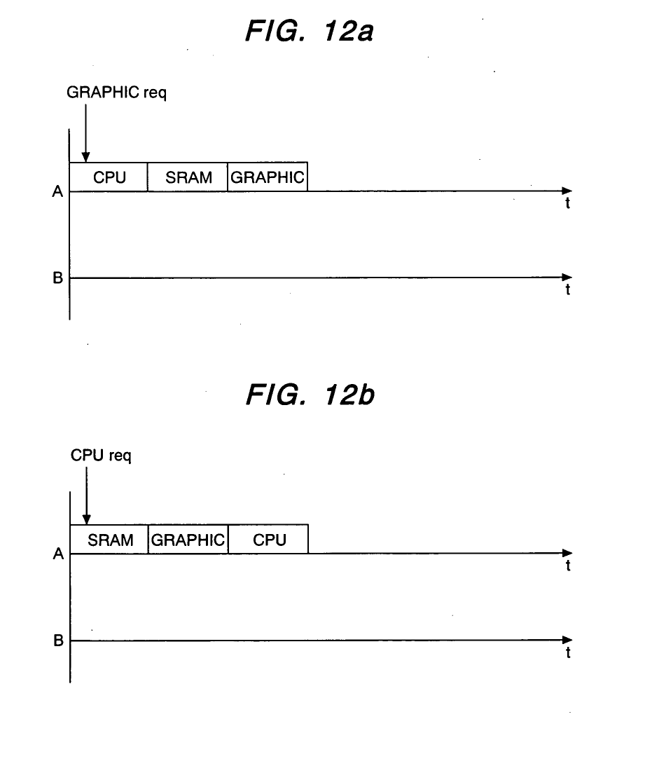

In FIG. 10, the access priority setting is different between the unified memories A and B. By setting different access priority between the unified memories A and B as set in FIG. 10, the worst latency for each device in case of access competition can be guaranteed. This will be described later, using FIG. 12.

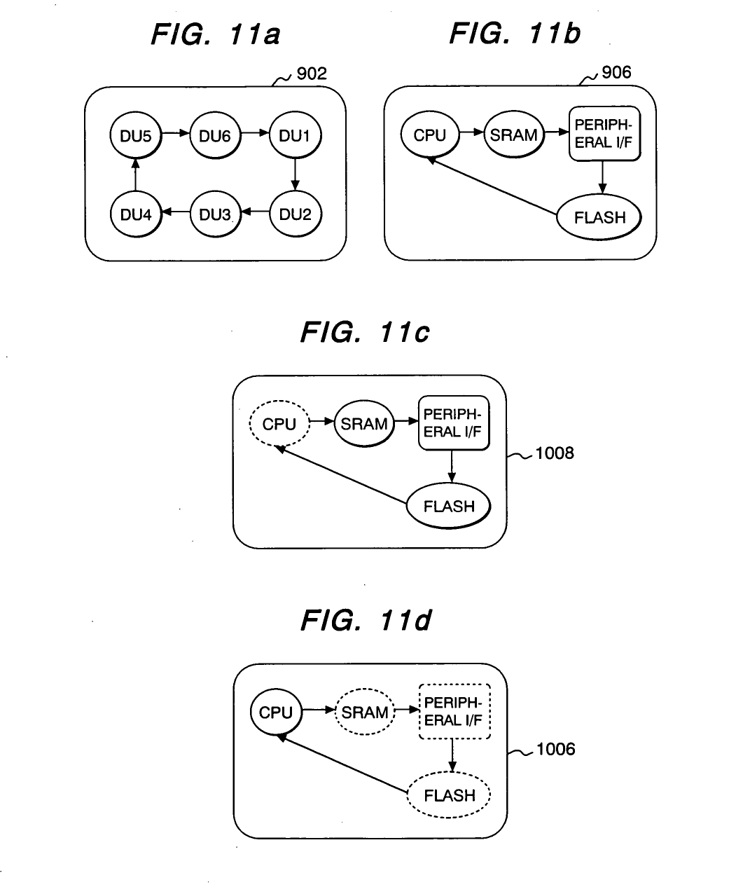

FIG. 11 is an explanatory figure of the sub-round robin for setting the priority of access to the unified memories A and B shown in FIG. 9 and FIG. 10. FIG. 11(a) shows the sub-round robin of the access priority for the display device 902 at Level 1 in FIG. 9. The priority arbitration is determined by round robin for the display device accesses DU1 to DU6 by six devices. The same applies to the display device accesses 912, 1002 and 1012. The display device accesses DU1 to DU6 correspond, for example, to the display accesses for superposing six screens.

FIG. 11(b) shows the sub-round robin for the access priority of the external device access 906 at Level 3 in FIG. 9. The priority arbitration is determined by round robin for each device: external CPU 206, SRAM 207, peripheral I/F 209, and FLASH 208. For the peripheral I/F 209, a sub-round robin for the devices to be connected with this is further provided (not shown). A similar sub-round robin is provided also for the external device access 916.

FIG. 11(c) shows the sub-round robin for the access priority of the external device access 1008 at Level 2 in FIG. 10. The priority arbitration is determined by round robin for each device: SRAM 207, peripheral I/F 209, and FLASH 208. The same applies to the external device access 1016. FIG. 11(d) shows the sub-round robin for the access priority of the external device access 1006 at Level 3 in FIG. 10. The CPU in this case is an external CPU 206. The same applies to the external device access 1018.

FIG. 12 is an explanatory figure showing the worst latency of the unified memory access from the view point of each device in a case where, under the access priority setting as shown in FIG. 9, only three accesses, CPU 201, data transmission from the SRAM 207 by the DMAC 225, and graphic device 223 compete with each other.

FIG. 12(a) shows the worst latency of the unified memory A from the view point of the graphic device 223. Under this worst situation, after the graphic device 223 has asserted a request (shown as “Graphic req” in the figure), the CPU 201 and data transmission from the SRAM 207 (shown as “CPU” and “SRAM” in the figure) are executed first, and then the access by the graphic device (shown as “Graphic” in the figure) is executed. Since the same priority setting as in the unified memory A is made in the unified memory B in FIG. 9, the same result as in FIG. 12(a) is produced.

FIG. 12(b) shows the worst latency of the unified memory A from the view point of the CPU 201. It is the worst latency for the CPU 201 if the data transmission from the SRAM 207 is executed first, and then the access by the graphic device 223 is executed, and the CPU access is executed last. The same result is produced in the unified memory B.

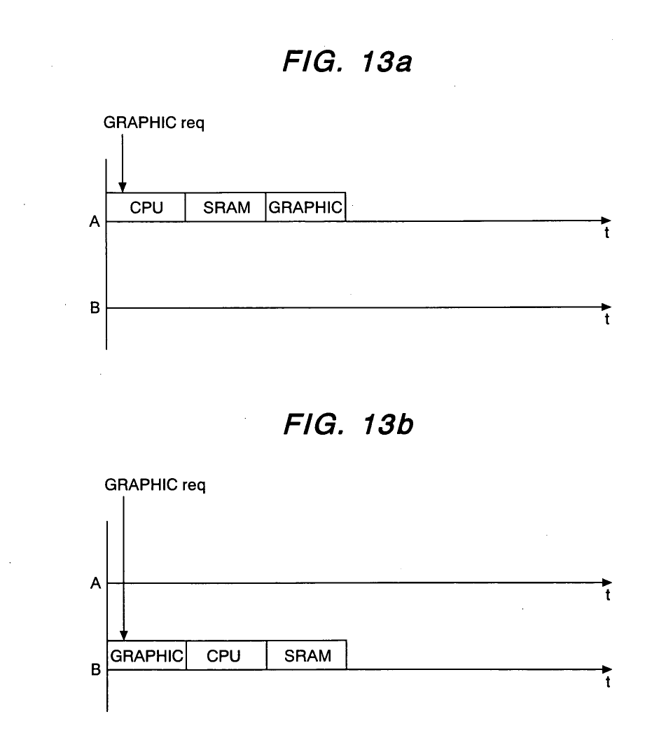

FIG. 13 is an explanatory figure showing the worst latency of the unified memory access from the view point of the graphic device 223 in a case where, under the access priority setting as shown in FIG. 10, only three accesses, CPU 201, data transmission from the SRAM 207 by the DMAC 225, and graphic device 223 compete with each other.

FIG. 13(a) shows the worst latency of the unified memory A from the view point of the graphic device 223. Under this worst situation, after the graphic device 223 has asserted a request “Graphic req”, the CPU 201 and data transmission from the SRAM 207 are executed first, and then the access by the graphic device 223 is executed.

FIG. 13(b) shows the worst latency of the unified memory B from the view point of the graphic device 223. Since the graphic device 223 is given the priority at Level 2, it is executed prior to the CPU 201 and data transmission from the SRAM 207. Compared to FIG. 13(a), the worst latency of the graphic device 223 is improved.

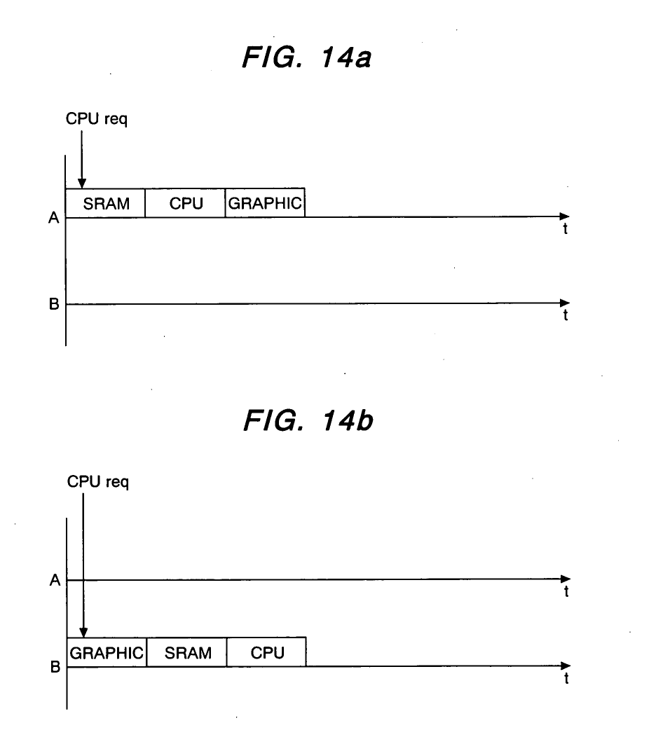

FIG. 14 is an explanatory figure showing the worst latency of the unified memory access from the view point of the CPU 201 in a case where, under the access priority setting as shown in FIG. 10, only three accesses, CPU 201, data transmission from the SRAM 207 by the DMAC 225, and graphic device 223 compete with each other.

FIG. 14(a) shows the worst latency of the unified memory A from the view point of the CPU 201. Under this worst situation, the access by the SRAM 207 which is given the priority at the same Level 2 as the CPU 201 is first executed, and then the access by the CPU 201 is executed.

FIG. 14(b) shows the worst latency of the unified memory B from the view point of the CPU 201. Since the CPU 201 is given the priority at Level 3, it is executed after the graphic device 223 and data transmission from the SRAM 207. Comparing FIG. 14(a) with (b), the worst latency from the view point of the CPU 201 is shorter in the unified memory A.

FIG. 13 and FIG. 14 show examples how the worst latency varies by setting the access priority differently between the unified memories A and B. In those examples, descriptions have been made based on a case where only three accesses, CPU 201, data transmission from the SRAM 207, and graphic device 223 compete with each other. However, under a situation where accesses by various devices such as display device (DU) at Level 1 and other peripheral I/F 209 compete with each other, it generally becomes difficult to guarantee the worst latency of an accessing device. Accordingly, as the present invention has made it possible to set the access priority independently for each line A and B of the unified memories, the worst latency can now be guaranteed more easily

The arbitration circuit 220 is described hereunder, using FIG. 15. FIG. 15 shows a construction of the arbitration circuit 220 in the system LSI 211. The arbitration circuit 220 comprises the first bus arbitration circuit 1501 to be connected with the first bus 213-1, 213-2 and second bus arbitration circuit 1502 to be connected with the second bus 222-1, 222-2. In addition, there are provided a priority setting register 1503, on-NMI request mask setting register 1504 and Level 1 continuation times setting register 1505 as the control registers for the bus arbitration circuit 1501. Similarly, there are provided a priority setting register 1506, request on-NMI request mask setting register 1507 and Level 1 continuation times setting register 1508 as the control registers for the bus arbitration circuit 1502.

The second bus arbitration circuit 1502 receives a request signal of each device from the second bus 222-1, 222-2 and determines the access priority according to the setting in the priority setting register 1506. In addition, if an NMI signal from the power monitor circuit 224 is received, the second bus arbitration circuit 1502 masks the request by a specified device from the second bus 222-1, 222-2 according to the setting in the on-NMI request mask setting register 1504 and arbitrates the request.

The first bus arbitration circuit 1501 receives a request signal of each device from the first bus 213-1, 213-2 and determines the access priority according to the setting in the priority setting register 1503. In addition, if an NMI signal from the power monitor circuit 224 is received, the first bus arbitration circuit 1501 masks the request by a specified device from the first bus 213-1, 213-2 according to the setting in the on-NMI request mask setting register 1504 and arbitrates the request.

The Level 1 continuation times setting register 1508 is a register for setting how many times of the access, which is given the priority at Level 1 by the priority setting as shown in FIG. 9, is allowed to continue in the arbitration of the second bus 222-1, 222-2. Similarly, the Level 1 continuation times setting register 1507 is a register for setting how many times of the access, which is given the priority at Level 1, is allowed to continue in the arbitration of the first bus 213-1, 213-2.

The default setting of both Level 1 continuous times setting registers 1507 and 1508 is “0” upon powering on, and this register value being set to “0” means “the bus can be occupied continuously without limitation of times so far as a request at Level 1 continues”. If the Level 1 continuation times setting register 1507 is set to “3” for example, it means “if the access by a device at Level 1 continues three times, a device at Level 2 can attain a bus right without fail (if a request at Level 2 is made)”. By utilizing the Level 1 continuous times setting registers 1507 and 1508 effectively, more flexible adjustment of the system performance becomes available.

As explained above, with a construction equipped with at least two lines of unified memories that can be connected with the system LSI 211, a separate purpose such as “mainly for display”, “mainly for main storage” or “all for display” is set to each line of the unified memories A and B based on the performance that needs to be given the priority. Then, the unified memories A and B are utilized separately by software based on the purpose and in accordance with the operating status of the data processing system. By controlling the separate utilization of the unified memories, the system performance can be well adjusted, for example, so as to give the priority to the CPU performance and data processing performance such as display processing performance. In addition, by constructing a car navigation system employing the system LSI 211, system cost and performance requirement become adjustable.

The system LSI 211 is equipped with at least two lines of unified memory interfaces corresponding to the number of connectable unified memories. If only one of the lines is employed in constructing a car navigation system, the system cost can be lowered. In this case, the performance of the system is expected to be equivalent to a unified memory system according to a conventional technique. If the performance of the whole system needs to be adjusted depending upon the operating status of the car navigation system, this adjustment can be made by connecting a memory such as SDRAM to each of the two lines of unified memory interfaces.

As explained above, only one system LSI 211 is applicable to different car navigation systems, that is, car navigation products from low cost to high end. Since only one system LSI 211 is applicable to multiple data processing system products, production volume of the system LSI 211 increases and the unit const of the system LSI 211 decreases due to mass-production. Consequently, the present invention contributes to lowering the cost of the data processing system products such as car navigation systems.

The invention made by the inventor has been described as above in terms of preferred embodiments, but it is needless to say that the present invention is not limited to the afore-mentioned embodiments but is modifiable so far as their intent is not lost.

The system LSI and data processing system of the present invention is applicable to a multi-media processing system such as car navigation system or telematics system in which the main storage access by the CPU and data processing access for displaying are both performed and accordingly merits of the invention can be enjoyed by adjusting the memory access performance.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

1. A system LSI comprising
a command processing section,
a display control section, and
a memory access control means which at least two physically different storage devices can be connected with and controls the access to the storage devices;
the storage area of the storage devices being capable of having an area to be accessed by the command processing section and an area to be accessed by the display control section; and
the area to be accessed by the command processing section for main storage purpose and the area to be accessed by the display control section for display purpose being utilized separately based on the purpose of the access to the at-least two storage devices via the memory access control means.

2. A system LSI according to claim 1, wherein
the method of memory access employed is such that the access to the at-least two storage devices can be specified using address.

3. A system LSI according to claim 1, wherein
the method of memory access employed is such that the access to the at-least two storage devices can be specified using register.

4. A data processing system comprising a system LSI according to claim 1, at least two physically different storage devices connected with the system LSI, and external devices;
the system LSI utilizing separately the area to be accessed by the command processing section and the area to be accessed by the display control section based on the purpose of the access to the at-least two storage devices, including the access by the external devices, and in accordance with the operating status of the system.

5. A system LSI according to claim 1, wherein the display control section has a function of controlling multiple image planes, and
has a means for specifying which storage device to access for each of the image planes.

6. A data processing system comprising a system LSI according to claim 5, at least two physically different storage devices connected with the system LSI, and external devices;
the system LSI utilizing separately the area to be accessed by the command processing section and the area to be accessed by the display control section based on the purpose of the access to the at-least two storage devices, including the access by the external devices, and in accordance with the operating status of the system.

7. A system LSI according to claim 5, wherein the function of controlling multiple image planes is a function of superposing the multiple image planes as a display plane, and which area of the storage device to access is specified for each of the image planes.

8. A data processing system comprising a system LSI according to claim 7, at least two physically different storage devices connected with the system LSI, and external devices;
the system LSI utilizing separately the area to be accessed by the command processing section and the area to be accessed by the display control section based on the purpose of the access to the at-least two storage devices, including the access by the external devices, and in accordance with the operating status of the system.

9. A system LSI according to claim 7, wherein the display control section has a register for specifying where to access for each of the image planes, and makes an access for each of the image planes in accordance with the setting in the register.

10. A data processing system comprising a system LSI according to claim 9, at least two physically different storage devices connected with the system LSI, and external devices;
the system LSI utilizing separately the area to be accessed by the command processing section and the area to be accessed by the display control section based on the purpose of the access to the at-least two storage devices, including the access by the external devices, and in accordance with the operating status of the system.

11. A system LSI comprising
a command processing section,
an image input section, and
a memory access control means which at least two physically different storage devices can be connected with and controls the access to the storage devices;
the storage area of the storage devices being capable of having an area to be accessed by the command processing section and an area to be accessed by the image input section; and
the area to be accessed by the command processing section for main storage purpose and the area to be accessed by the image input section for image input purpose being utilized separately based on the purpose of the access to the at-least two storage devices via the memory access control means.

12. A system LSI according to claim 11, wherein the method of memory access employed is such that the access to the at-least two storage devices can be specified using register.

13. A system LSI according to claim 11, wherein the method of memory access employed is such that the access to the at-least two storage devices can be specified using address.

14. A data processing system comprising a system LSI according to claim 11, at least two physically different storage devices connected therewith, and external devices;
the system LSI utilizing separately the area to be accessed by the command processing section and the area to be accessed by the image input section based on the purpose of the access to the at-least two storage devices, including the access by the external devices, and in accordance with the operating status of the system.

15. A system LSI comprising
a command processing section,
a voice processing section, and
a memory access control means which at least two physically different storage devices can be connected with and controls the access to the storage devices;
the storage area of the storage devices being capable of having an area to be accessed by the command processing section and an area to be accessed by the voice processing section; and
the area to be accessed by the command processing section for main storage purpose and the area to be accessed by the voice processing section for voice processing purpose being utilized separately based on the purpose of the access to the at-least two storage devices via the memory access control means.

16. A system LSI according to claim 15, wherein
the method of memory access employed is such that the access to the at-least two storage devices can be specified using address.

17. A system LSI according to claim 15, wherein
the method of memory access employed is such that the access to the at-least two storage devices can be specified using register.

18. A data processing system comprising a system LSI according to claim 15, at least two physically different storage devices connected therewith, and external devices;
the system LSI utilizing separately the area to be accessed by the command processing section and the area to be accessed by the voice processing section based on the purpose of the access to the at-least two storage devices, including the access by the external devices, and in accordance with the operating status of the system.
